(19) United States
(12) Patent Application Publication
(10) Pub. No.: US 2025/0147335 A1
(43) Pub. Date: May 8, 2025

(54) OPTICAL MODULE AND CAMERA MODULE INCLUDING OPTICAL MODULE

(71) Applicant: Samsung Electro-Mechanics Co., Ltd., Suwon-si (KR)

(72) Inventors: Bo Sung SEO, Suwon-si (KR); Young Hwan KWON, Suwon-si (KR)

(73) Assignee: Samsung Electro-Mechanics Co., Ltd., Suwon-si (KR)

(21) Appl. No.: 18/931,820

(22) Filed: Oct. 30, 2024

(30) Foreign Application Priority Data
Nov. 6, 2023 (KR) 10-2023-0152185
Jul. 12, 2024 (KR) 10-2024-0092484

(51) Int. Cl. G02B 27/64; G02B 7/18; H04N 23/68

(52) U.S. Cl. CPC G02B 27/646; G02B 7/08; G02B 7/1805; H04N 23/687

(57) ABSTRACT

An optical module includes a housing; a guide member disposed in the housing and configured to be rotatable about a first rotational axis; an optical member configured to be rotatable about the first rotational axis together with the guide member; a first ball member disposed between the housing and the guide member and including a plurality of balls; and a protrusion disposed on the housing or the guide member and protruding in a direction of the first rotational axis, wherein the plurality of balls of the first ball member are configured to roll while being in contact with an outer surface of the protrusion.

### CROSS-REFERENCE TO RELATED APPLICATIONS

This application claims the benefit under 35 USC 119 (a) of Korean Patent Application Nos. 10-2023-0152185 filed on Nov. 6, 2023, and 10-2024-0092484 filed on Jul. 12, 2024, n the Korean Intellectual Property Office, the entire disclosures of which are incorporated herein by reference for all purposes.

### BACKGROUND

### 2. Field

The present disclosure relates to an optical module and a camera module including an optical module.

### 3. Description of Related Art

Recently, a camera module which may bend a traveling path of light through a reflective module disposed in front of a lens module may be employed in a mobile device.

A camera module may have an optical image stabilization function for compensating for shaking during photographing to increase resolution, and the optical image stabilization function may be implemented through a two-axis rotation of the reflective module. For example, the reflective module may rotate about two axes perpendicular to an optical axis of a lens module and perpendicular to each other as rotation axes.

A plurality of balls may be used to support rotational movement of the reflective module. The plurality of balls may be disposed between the reflective module and the housing and may be in contact with both the reflective module and the housing.

In this case, a force may need to be applied to the plurality of balls to keep the plurality of balls in contact with the reflective module and the housing. However, as the reflective module rotates, there may be a deviation in the force applied to the plurality of balls, and rotation of the reflective module may not be smooth.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical module includes a housing; a guide member disposed in the housing and configured to be rotatable about a first rotational axis; an optical member configured to be rotatable about the first rotational axis together with the guide member; a first ball member disposed between the housing and the guide member and including a plurality of balls; and a protrusion disposed on the housing or the guide member and protruding in a direction of the first rotational axis, wherein the plurality of balls of the first ball member are configured to roll while being in contact with an outer surface of the protrusion.

The plurality of balls of the first ball member may be in contact with both the housing and the guide member, and either one or both of a surface of the housing in contact with the plurality of balls and a surface of the guide member in contact with the plurality of balls may be inclined with respect to the first rotational axis.

The protrusion may have a truncated cone shape having a cross-sectional area that changes in a direction of the first rotational axis.

The plurality of balls of the first ball member may be in two-point contact with the housing, and in two-point contact with the guide member.

A length of the protrusion in the direction of the first rotational axis may be smaller than a diameter of each of the plurality of balls of the first ball member.

The optical module may further include a retainer disposed to be rotatable with respect to the protrusion, wherein the retainer may include a body and a support extending from the body, and the support may be disposed between the plurality of balls of the first ball member.

The optical module may further include a sub-ball member including a plurality of sub-balls each having a diameter smaller than a diameter of each of the plurality of balls, wherein the plurality of sub-balls of the sub-ball member may be disposed between the plurality of balls of the first ball member.

The optical module may further include a first magnet disposed on the guide member and including a 1-1 magnet and a 1-2 magnet, wherein the 1-1 magnet and the 1-2 magnet may be spaced apart from each other in a direction perpendicular to a direction of the first rotational axis, and the first ball member may be disposed between the 1-1 magnet and the 1-2 magnet.

The optical module may further include a first coil disposed on the housing and facing one surface of the first magnet, wherein the one surface of the first magnet may include an N pole and an S pole spaced apart from each other in a direction perpendicular to the direction of the first rotational axis.

The optical module may further include a first pulling yoke disposed on the housing and spaced apart from the first magnet in the direction of the first rotational axis.

The optical module may further include a lens module having an optical axis, wherein the optical member may be a reflective member including a reflective surface configured to reflect light, the lens module may be disposed so that light reflected from the reflective member is incident on the lens module in an optical axis direction of the lens module, and the optical module may further include a sensing magnet disposed on the guide member and spaced apart from the protrusion in the optical axis direction of the lens module, and a first position sensor disposed on the housing and facing the sensing magnet.

The optical module may further include a holder on which the optical member is mounted, the holder being configured to be rotatable with respect to the guide member about a second rotational axis perpendicular to the first rotational axis; a second magnet disposed on the holder; and a second coil facing the second magnet.

The optical module may further include a lens module having an optical axis, wherein the optical member may be a reflective member including a reflective surface configured to reflect light, the lens module may be disposed so that light reflected from the reflective member is incident on the lens module in an optical axis direction of the lens module, and the optical module may further include a second position sensor disposed on the housing and facing the second magnet so that a virtual line formed by extending the optical axis of the lens module passes through the second position sensor.

The optical module may further include a second ball member disposed between the holder and the guide member and including a plurality of balls spaced apart from each other in a direction of the second rotational axis.

In another general aspect, a camera module includes a holder; a reflective member disposed on the holder and configured to reflect light; a guide member on which the holder is disposed; a housing in which the holder and the guide member are disposed; a first ball member disposed between the guide member and the housing and including a plurality of balls; and a first lens module having a first optical axis and on which light reflected from the reflective member is incident, wherein the guide member is configured to be rotatable together with the holder about a first rotational axis, the holder is configured to be rotatable relative to the guide member about a second rotational axis perpendicular to the first rotational axis, one of the housing and the guide member comprises a protrusion protruding in a direction of the first rotational axis, and another one of the housing and the guide member includes a guide groove, the plurality of balls of the first ball member are in contact with a surface of the protrusion and a surface of the guide groove, and either one or both of the surface of the protrusion in contact with the plurality of balls of the first ball member and the surface of the guide groove in contact with the plurality of balls of the first ball member is an inclined surface that is inclined with respect to the first rotational axis.

The camera module may further include a first magnet including two magnets disposed on the guide member, wherein the two magnets of the first magnet may be spaced apart from each other in a direction perpendicular to the direction of the first rotational axis, and the camera module may further include a first pulling yoke disposed on the housing and spaced apart from the first magnet in the direction of the first rotational axis.

The plurality of balls of the first ball member may be in contact with an outer surface of the protrusion, and a diameter of each of the plurality of balls of the first ball member may be greater than a length of the protrusion in the direction of the first rotational axis.

A lubrication groove may be formed in either one or both of a surface of the housing in contact with the plurality of balls of the first ball member and a surface of the guide member in contact with the plurality of balls of the first ball member, and the camera module may further include a lubricant disposed in the lubrication groove.

The camera module may further include a second lens module having a second optical axis and disposed on the holder so that the second lens module is disposed in front of the reflective member, wherein the first optical axis and the second optical axis may be perpendicular to each other.

The direction of the first rotational axis may be the same as or parallel to a direction of the second optical axis, and a direction of the second rotational axis may be perpendicular to both the first optical axis and the second optical axis.

The direction of the first rotational axis may be the same as or parallel to a direction of the first optical axis, and a direction of the second rotational axis may be perpendicular to both the first optical axis and the second optical axis.

In another general aspect, an optical module includes a housing; and a reflective module disposed in the housing and configured to be rotatable about a first rotational axis with respect to the housing, wherein a first guide groove having a circular planar shape centered on the first rotational axis is formed in a surface of the reflective module facing the housing, a second guide groove having a circular planar shape centered on the first rotational axis is formed in a surface of the housing facing the surface of the reflective module in which the first guide groove is formed, the optical module further includes a first ball member including a plurality of balls disposed between the first guide groove and the second guide groove, and the plurality of balls of the first ball member are equidistantly spaced apart from one another in a circumferential direction around the first rotational axis and are configured to roll in the circumferential direction while the reflective module rotates with respect to the housing.

The optical module may further include a protrusion having a circular planar shape centered on the first rotational axis and disposed in either one or both of the first guide groove and the second guide groove, wherein the plurality of balls of the first ball member may be disposed between an outer surface of the protrusion and an inner wall surface of the first guide groove or an inner wall surface of the second guide groove, and may be further configured to roll in the circumferential direction while being in contact with the outer surface of the protrusion as the reflective module rotates with respect to the housing.

The optical module may further include a retainer including a body and a plurality of supports extending from the body in a direction of the first rotational axis, wherein the retainer may be disposed between the first groove and the second groove so that the plurality of supports are disposed between the plurality of balls of the first ball member.

The plurality of balls of the first ball member may include a first plurality of balls and a second plurality of balls, and the first plurality of balls and the second plurality of balls may be spaced apart from each other in the direction of the first rotational axis.

The optical module may further include a sub-ball member including a plurality of sub-balls disposed between the plurality of balls of the first ball member.

The optical module may further include a barrier wall disposed in either one or both of the first guide groove and the second guide groove and between the plurality of balls of the first ball member.

The reflective module may includes a guide member disposed in the housing and configured to be rotatable about the first rotational axis with respect to the housing; a holder disposed in the guide member and configured to be rotatable together with the guide member about the first rotational axis with respect to the housing, and to be rotatable about a second rotational axis perpendicular to the first rotational axis with respect to the guide member; and a reflective member disposed in the holder and configured to be rotatable together with the holder and the guide member about the first rotational axis with respect to the housing, and to be rotatable together with the holder about the second rotational axis with respect to the guide member, wherein the first guide groove may be formed in a surface of the guide member facing the surface of the housing in which the second guide groove is formed.

In another general aspect, a optical module includes a housing; a reflective module disposed in the housing and configured to be rotatable about a first rotational axis with respect to the housing; a first coil disposed on a surface of the housing facing the reflective module; a first magnet disposed on a surface of the reflective module facing the surface of the housing on which the first coil is disposed so that the first magnet faces the first coil; and a first ball member including a plurality of balls disposed between the surface of the housing on which the first coil is disposed and the surface of the reflective module on which the first magnet is disposed, wherein the first coil and the first magnet are configured to rotate the reflective module about the first rotational axis with respect to the housing, and the plurality of balls of the first ball member are equidistantly spaced apart from one another other in a circumferential direction around the first rotational axis and are configured to roll in the circumferential direction while the reflective module rotates with respect to the housing.

The first magnet may include two magnets disposed on opposite sides of the plurality of balls of the first ball member in a direction perpendicular to the first rotational axis, and the first coil may include two coils facing the two magnets of the first magnet.

A first guide groove having a circular planar shape centered on the first rotational axis may be formed in the surface of the reflective module on which the first magnet is disposed, a second guide groove having a circular planar shape centered on the first rotational axis may be formed in the surface of the housing on which the first coil is disposed, and the plurality of balls of the first ball member may be disposed between the first guide groove and the second guide groove.

The optical module may further include a protrusion having a circular planar shape centered on the first rotational axis and disposed in either one or both of the first guide groove and the second guide groove, wherein the plurality of balls of the first ball member may be disposed between an outer surface of the protrusion and an inner wall surface of the first guide groove or an inner wall surface of the second guide groove, and may be further configured to roll in the circumferential direction while being in contact with the outer surface of the protrusion as the reflective module rotates with respect to the housing.

Other features and aspects will be apparent from the following detailed description, the drawings, and the claims.

### BRIEF DESCRIPTION OF DRAWINGS

FIG. 1 is a perspective diagram illustrating a camera module according to an embodiment of the present disclosure.

FIG. 2 is an exploded perspective diagram illustrating the camera module of FIG. 1.

FIG. 3 is a perspective diagram illustrating a state in which a case is removed from the camera module of FIG. 1.

FIG. 4 is a perspective diagram illustrating an exploded state of a first lens module of FIG. 3.

FIG. 5 is a perspective diagram illustrating a reflective module of FIG. 2.

FIG. 6 is an exploded perspective diagram illustrating the reflective module of FIG. 5.

FIG. 7 is a perspective diagram illustrating a holder and a guide member of the reflective module of FIG. 6 viewed from below.

FIG. 8 is a diagram illustrating a support structure of a first ball member of FIGS. 2, 6, and 7, and illustrating the guide member and the housing of FIGS. 6 and 7 in simplified form for ease of illustration.

FIG. 9 is a cross-sectional diagram illustrating a state in which components illustrated in FIG. 8 are coupled to each other.

FIG. 10 is a diagram illustrating a modified example of FIG. 9.

FIG. 11 is a diagram illustrating a first modified example of FIG. 8.

FIG. 12 is a diagram illustrating a second modified example of FIG. 8.

FIGS. 13 to 15 are diagrams illustrating modified examples of a first magnet of FIGS. 6 and 7.

FIGS. 16 and 17 are perspective diagrams illustrating a second lens module of FIG. 2 separated from the camera module of FIG. 1.

FIG. 18 is a perspective diagram illustrating a camera module according to another embodiment of the present disclosure.

FIG. 19 is an exploded perspective diagram illustrating the camera module of FIG. 18.

FIG. 20 is an exploded perspective diagram illustrating a reflective module of FIG. 19.

FIG. 21 is an exploded perspective diagram illustrating a holder and a guide member of the reflective module of FIG. 20 viewed from below.

FIG. 22 is a diagram illustrating an example of a support structure of a first ball member illustrated in FIGS. 20 and 21, and illustrating a guide member and a housing of FIGS. 20 and 21 in simplified form for ease of illustration.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Embodiments relate to an optical module and a camera module, and the camera module may be mounted in portable electronic devices such as a mobile communication terminal, a smartphone, and a tablet PC.

The optical module may include an optical member. In embodiments, the optical module may be understood to include any one or any combination of any two or more of a lens module, a reflective module, and an image sensor module. Also, the optical member may refer to any one or any combination of any two or more of a lens, a reflective member, and an image sensor.

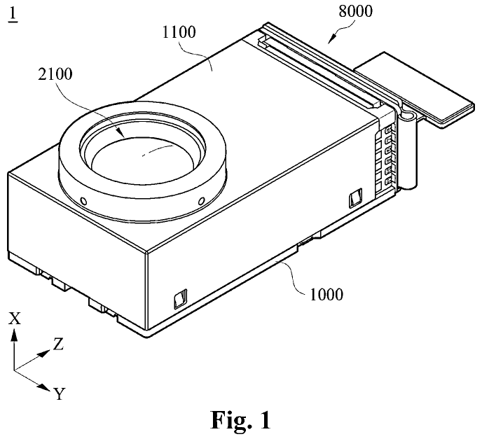

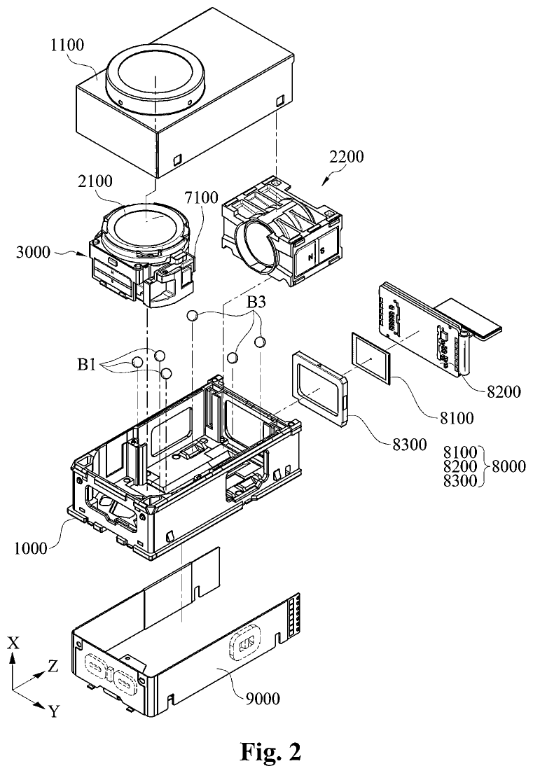

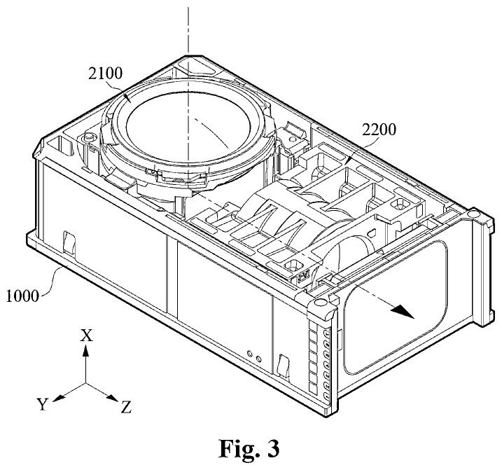

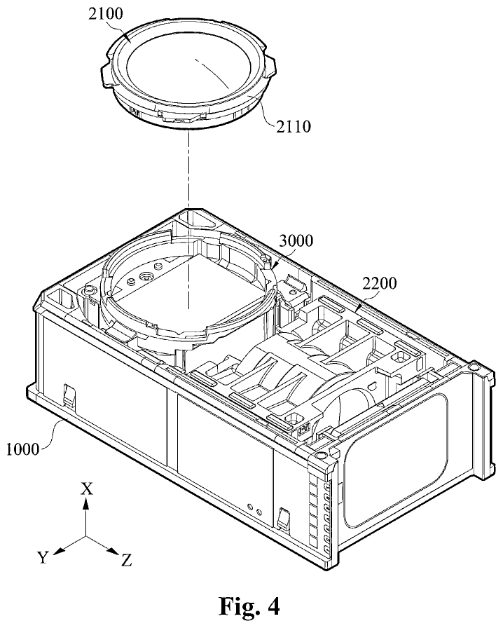

FIG. 1 is a perspective diagram illustrating a camera module according to an embodiment of the present disclosure. FIG. 2 is an exploded perspective diagram illustrating the camera module of FIG. 1. FIG. 3 is a perspective diagram illustrating a state in which a case is removed from the camera module of FIG. 1. FIG. 4 is a perspective diagram illustrating an exploded state of a first lens module illustrated in FIG. 3.

Referring to FIGS. 1 to 4, a camera module 1 according to an embodiment of the present disclosure may include a first lens module 2100, a reflective module 3000, a second lens module 2200, and a housing 1000.

The first lens module 2100 may include at least one lens and a first lens barrel 2110. At least one lens may have a first optical axis (X-axis) and may be mounted on the first lens barrel 2110. The first optical axis (X-axis) may extend in a vertical direction in FIG. 4.

The first lens module 2100 may be disposed in front of the reflective module 3000, i.e., on the front side of the reflective module 3000. The phrase “front side of the reflective module 3000” may indicate a positive first optical axis (X-axis) direction (+X-axis direction) with respect to the reflective module 3000. For example, the first lens module 2100 may be disposed above the reflective module 3000 in the first optical axis (X-axis) direction.

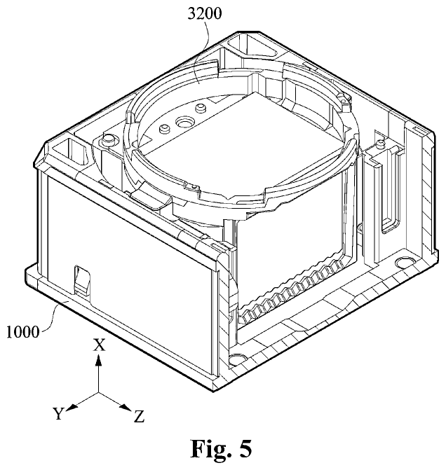

The first lens module 2100 may be coupled to the reflective module 3000. For example, the first lens module 2100 may be coupled to a holder 3200 of the reflective module 3000 shown in FIGS. 5 to 7.

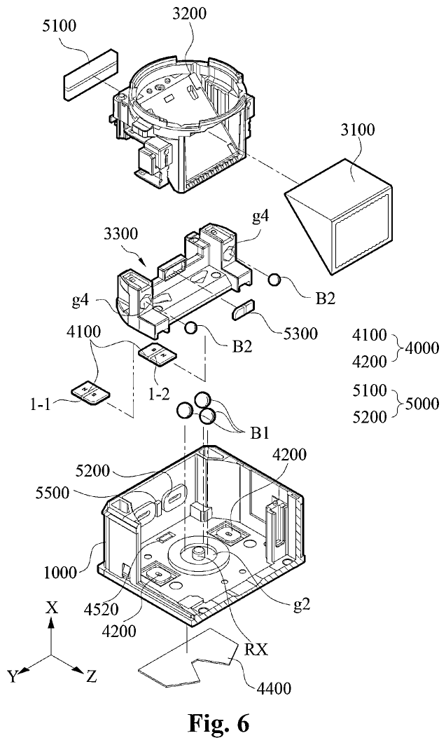

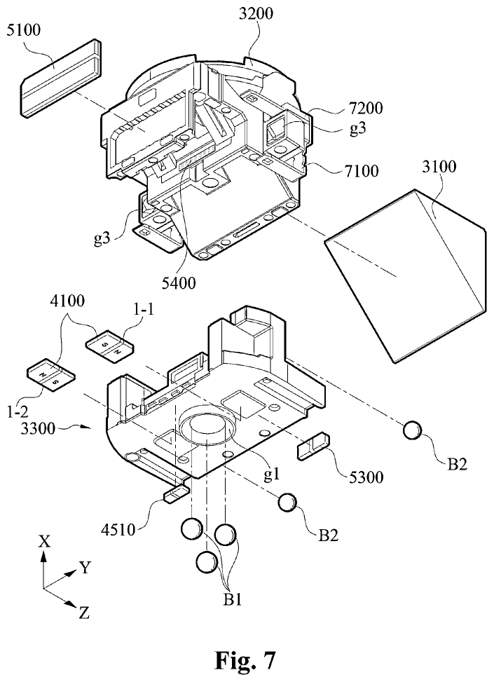

The reflective module 3000 may include a reflective member 3100 shown in FIGS. 6 and 7, and the reflective member 3100 may have a reflective surface reflecting light passing through the first lens module 2100. For example, the reflective member 3100 may be a prism or a mirror. The reflective member 3100 may be coupled to the holder 3200.

The first lens module 2100 and the reflective module 3000 may be disposed in the housing 1000.

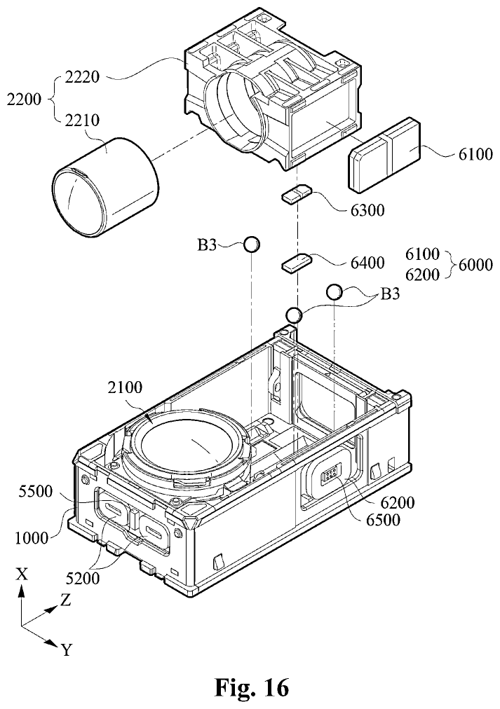

In an embodiment, the camera module 1 may further include a second lens module 2200. The reflective module 3000 may be disposed between the first lens module 2100 and the second lens module 2200. The second lens module 2200 may include a plurality of lenses and a second lens barrel 2210 shown in FIG. 16. The plurality of lenses may have a second optical axis (Z-axis) and may be mounted on the second lens barrel 2210.

The first optical axis (X-axis) of the first lens module 2100 and the second optical axis (Z-axis) of the second lens module 2200 may be perpendicular to each other.

The first lens module 2100 may include one or more lenses, and the second lens module 2200 may include a plurality of lenses.

The one or more lenses of the first lens module 2100 may have a circular shape when viewed in the first optical axis (X-axis) direction. At least one lens among the plurality of lenses of the second lens module 2200 may have a non-circular shape when viewed in the second optical axis (Z-axis) direction. For example, the non-circular lens may have different dimensions in two directions perpendicular to the second optical axis (Z-axis) direction and perpendicular to each other. In an embodiment, a length in the first axis (Y-axis) direction of the non-circular lens, perpendicular to both the first optical axis (X-axis) direction and the second optical axis (Z-axis) direction, may be greater than a width of the non-circular lens in the first optical axis (X-axis) direction.

In embodiments, the camera module 1 may include the first lens module 2100 and the second lens module 2200, but an embodiment thereof is not limited thereto, and the camera module 1 may include only one of the first lens module 2100 and the second lens module 2200.

In an embodiment, the first lens module 2100 and the reflective member 3100 may be configured to rotate together for optical image stabilization. That is, the first lens module 2100 and the reflective member 3100 may rotate together about two axes perpendicular to each other.

For example, the first lens module 2100 and the reflective member 3100 may rotate together about the first optical axis (X-axis) as a rotational axis, and may rotate together about the first axis (Y-axis) perpendicular to both the first optical axis (X-axis) and the second optical axis (Z-axis) as a rotational axis.

In an embodiment, the second lens module 2200 may move in the second optical axis (Z-axis) direction for focus adjustment.

The camera module 1 may further include an image sensor module 8000.

The image sensor module 8000 may include a sensor housing 8300, an image sensor 8100, and a printed circuit board 8200, and may further include an infrared cut-off filter (not shown).

The infrared cut-off filter may be mounted on the sensor housing 8300. The infrared cut-off filter may block light in the infrared region.

The printed circuit board 8200 may be coupled to the sensor housing 8300, and the image sensor 8100 may be mounted on the printed circuit board 8200.

Light passing through the second lens module 2200 may be received by the image sensor module 8000 (e.g., the image sensor 8100).

The camera module 1 may further include a case 1100. The case 1100 may be coupled to the housing 1000 to cover an upper portion of the housing 1000. The case 1100 may have an opening, and the first lens module 2100 may be disposed in the opening.

The first lens module 2100 may be disposed so that at least a portion of the first lens module may protrude externally from the housing 1000.

FIG. 5 is a perspective diagram illustrating a reflective module of FIG. 2. FIG. 6 is an exploded perspective diagram of the reflective module of FIG. 5. FIG. 7 is a perspective diagram illustrating a holder and a guide member of the reflective module of FIG. 6 viewed from below.

Referring to FIGS. 5 to 7, a reflective module 3000 may include a reflective member 3100, a holder 3200, and a guide member 3300.

The reflective member 3100 may have a reflective surface reflecting light passing through the first lens module 2100. For example, the reflective member 3100 may be a prism or a mirror.

When the reflective member 3100 is a prism, the reflective member 3100 may have a shape of a rectangular solid or a cube divided into two halves in a diagonal direction. The prism may include an incident surface to which light is incident, a reflective surface reflecting light passing through the incident surface, and an exit surface through which light reflected from the reflective surface is emitted.

The reflective member 3100 may be mounted on the holder 3200. The first lens module 2100 may be disposed on the front side of the reflective member 3100. In an embodiment, the first lens module 2100 may be mounted on the holder 3200.

The holder 3200 may be disposed on the guide member 3300 and may rotate. Also, the guide member 3300 may be disposed on the housing 1000 and may rotate.

The guide member 3300 may rotate about the first optical axis (X-axis) as a rotational axis. For example, the guide member 3300 may rotate relative to the housing 1000 about the first optical axis (X-axis) as the rotational axis. In this case, the first lens module 2100 and the holder 3200 may also rotate together with the guide member 3300. The first optical axis (X-axis) may also be referred to as a first rotational axis.

The holder 3200 may rotate about the first axis (Y-axis) perpendicular to both the first optical axis (X-axis) and the second optical axis (Z-axis) as a rotational axis. For example, the holder 3200 may rotate relative to the guide member 3300 about the first axis (Y-axis) as the rotational axis. In this case, the first lens module 2100 may rotate together with the holder 3200. The first axis (Y-axis) may also be referred to as a second rotational axis.

A first driver 4000 may be provided to rotate the reflective module 3000. The first driver 4000 may include a first magnet 4100 and a first coil 4200. The guide member 3300 may be rotated relative to the housing 1000 about to the first optical axis (X-axis) by the first driver 4000. Since the holder 3200 and the first lens module 2100 are disposed on the guide member 3300, the holder 3200 and the first lens module 2100 may also rotate together with the guide member 3300.

The first magnet 4100 may be mounted on the guide member 3300. For example, the first magnet 4100 may be mounted on one surface of the guide member 3300. In an embodiment, the one surface of the guide member 3300 may be a surface of the guide member 3300 facing the housing 1000 in the first optical axis (X-axis) direction. For example, the one surface of the guide member 3300 may be a lower surface of the guide member 3300. The first magnet 4100 may include two magnets spaced apart from each other.

The two magnets may be disposed so that length directions of the two magnets are parallel to the second optical axis (Z-axis), and may be spaced apart from each other in the first axis (Y-axis) direction.

The two magnets of the first magnet 4100 may be magnetized so that one surface (e.g., a surface facing the first coil 4200) may have a first polarity and a second polarity. Hereinafter, the first polarity and the second polarity may be opposite polarities, and when the first polarity is an N pole, the second polarity is an S pole.

In an embodiment, one of the two magnets of the first magnet 4100 (hereinafter, referred to as a 1-1 magnet) may have a first polarity and a second polarity along the second optical axis (Z-axis) on one surface facing the first coil 4200, and a neutral region may be formed between the first polarity and the second polarity.

The other of the two magnets of the first magnet 4100 (hereinafter referred to as a 1-2 magnet) may have a second polarity and a first polarity along the second optical axis (Z-axis) on one surface facing the first coil 4200, and a neutral region may be formed between the second polarity and the first polarity.

The first coil 4200 may be disposed at a position facing the first magnet 4100. In an embodiment, the first coil 4200 may be disposed to face the first magnet 4100 in the first optical axis (X-axis) direction.

The first coil 4200 may be disposed on a substrate 9000, and the substrate 9000 may be mounted on the housing 1000 so that the first magnet 4100 and the first coil 4200 may face each other in the first optical axis (X-axis) direction.

The housing 1000 may include a through-hole passing through the housing 1000 in the first optical axis (X-axis) direction, and the first coil 4200 may be disposed in the through-hole and may directly face the first magnet 4100.

The first coil 4200 may include two coils. The two coils may be spaced apart from each other in the first axis (Y-axis) direction.

During optical image stabilization, the first magnet 4100 may be configured as a moving member mounted on the guide member 3300 and rotating together with the guide member 3300, and the first coil 4200 may be configured as a fixed member fixed to the substrate 9000.

When power is applied to the first driver 4000, the first driver 4000 may generate a driving force to rotate the guide member 3300 about the first optical axis (X-axis) as a rotational axis.

A first ball member B1 may be disposed between the guide member 3300 and the housing 1000. The first ball member B1 may include a plurality of balls.

One of the guide member 3300 and the housing 1000 may include a protrusion RX. For example, the housing 1000 may include a protrusion RX. In an embodiment, the protrusion RX may protrude from a bottom surface of the housing 1000 in the first optical axis (X-axis) direction. A virtual line formed by extending the first optical axis (X-axis) of the first lens module 2100 may pass through the protrusion RX. A bottom surface of the housing 1000 may be a plane perpendicular to the first optical axis (X-axis).

In an embodiment, the protrusion RX may be integrated with the housing 1000. Alternatively, the protrusion RX may be provided as a member separate from the housing 1000 and may be configured to be fixed to the housing 1000.

The protrusion RX may form a rotational axis of the guide member 3300.

The plurality of balls of the first ball member B1 may be disposed around the protrusion RX. For example, the plurality of balls may be in contact with the outer surface of the protrusion RX.

An attractive force may be applied between the guide member 3300 and the housing 1000. In an embodiment, a first pulling yoke 4400 may be disposed at a position facing the first magnet 4100 and the first optical axis (X-axis).

The first pulling yoke 4400 may be disposed on the substrate 9000. For example, the first coil 4200 may be disposed on an inner surface of the substrate 9000, and the first pulling yoke 4400 may be disposed on an outer surface of the substrate 9000.

The first magnet 4100 and the first pulling yoke 4400 may generate an attractive force therebetween. For example, the first pulling yoke 4400 may be made of a magnetic material.

The attractive force may be generated in the first optical axis (X-axis) direction between the first magnet 4100 and the first pulling yoke 4400.

The first ball member B1 may be kept in contact with the guide member 3300 and the housing 1000 by the attractive force generated between the first magnet 4100 and the first pulling yoke 4400.

A first guide groove g1 may be formed in the guide member 3300. For example, the first guide groove g1 may be formed in the lower surface of the guide member 3300. Also, the first guide groove g1 may be formed between the 1-1 magnet and the 1-2 magnet.

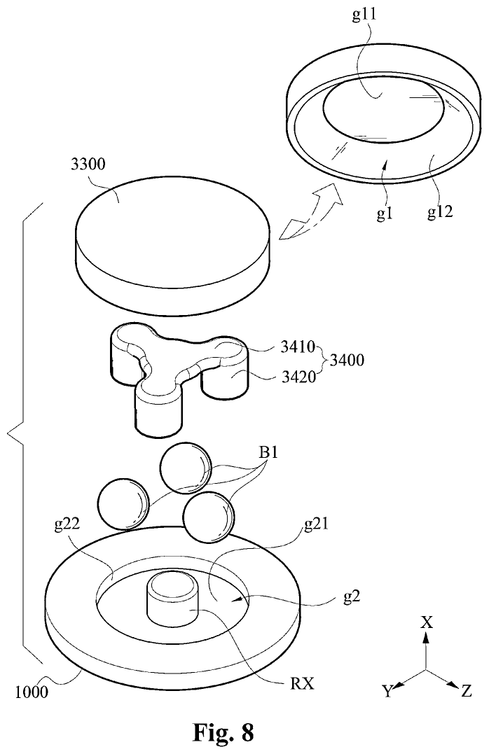

A planar shape of the first guide groove g1 may be circular. For example, an inner wall surface g12 (see FIGS. 8 to 12) of the first guide groove g1 may have a curved shape. That is, the inner wall surface g12 of the first guide groove g1 may curve around a center of the first guide groove g1 in a circular path.

A second guide groove g2 may be formed in the housing 1000. For example, the second guide groove g2 may be formed in a bottom surface of the housing 1000. Also, the second guide groove g2 may be formed between two coils of the first coil 4200.

A planar shape of the second guide groove g2 may be circular. For example, an inner wall surface g22 (see FIGS. 8 to 12) of the second guide groove g2 may have a curved shape. That is, the inner wall surface g22 of the second guide groove g2 may curve around a center of the second guide groove g2 in a circular path.

The protrusion RX may protrude in the first optical axis (X-axis) direction from a bottom surface g21 (see FIGS. 8 to 12) of the second guide groove g2. At least a portion of the protrusion RX may protrude externally from the second guide groove g2.

The first guide groove g1 and the second guide groove g2 may face each other in the first optical axis (X-axis) direction.

The first ball member B1 may be disposed around the protrusion RX in contact with the protrusion RX, and may be disposed between the first guide groove g1 and the second guide groove g2.

The guide member 3300 may be rotated about the first optical axis (X-axis) by the driving force generated by the first driver 4000, and in this case, the first ball member B1 may roll with respect to the protrusion RX between the first guide groove g1 and the second guide groove g2.

Although FIGS. 6 and 7 illustrate an embodiment in which the first magnet 4100 is disposed on the lower surface of the guide member 3300, the position of the first magnet 4100 is not limited thereto.

For example, the first magnet 4100 may be disposed on a side surface of the guide member 3300. When the first magnet 4100 is configured as one magnet, the first magnet 4100 may be disposed on one side surface of the guide member 3300. When the first magnet 4100 is configured as two magnets (e.g., a 1-1 magnet and a 1-2 magnet), the two magnets may be disposed separately on one side surface and the other side surface of the guide member 3300. The one side surface of the guide member 3300 and the other side surface may be spaced apart from each other in the first axis (Y-axis) direction.

In this case, a pulling magnet (not shown) facing the first pulling yoke 4400 may be disposed on the lower surface of the guide member 3300.

In an embodiment, the camera module 1 may sense a position of the guide member 3300. To this end, a sensing magnet 4510 and a first position sensor 4520 may be provided.

When the guide member 3300 rotates about the first optical axis (X-axis) as the rotational axis, a position of the guide member 3300 may be sensed by the sensing magnet 4510 and the first position sensor 4520.

The sensing magnet 4510 may be disposed on one surface (e.g., the lower surface) of the guide member 3300. Also, the sensing magnet 4510 may be disposed at a position spaced apart from the first magnet 4100. For example, the sensing magnet 4510 may be spaced apart from the 1-1 magnet and the 1-2 magnet.

In an embodiment, the sensing magnet 4510 may be spaced apart from the protrusion RX in the second optical axis (Z-axis) direction.

The sensing magnet 4510 may be magnetized so that one surface (e.g., a lower surface) may have both an N pole and an S pole. In an embodiment, the one surface of the sensing magnet 4510 may have an N pole, a neutral region, and an S pole arranged in order in the first axis (Y-axis) direction.

A virtual line extending from the neutral region of the sensing magnet 4510 in the second optical axis (Z-axis) direction may pass through the protrusion RX.

Since the camera module 1 includes a sensing magnet 4510 for sensing the position of the guide member 3300, a size of the first coil 4200 facing the first magnet 4100 may be sufficiently increased. Accordingly, a size of the driving force generated by the first driver 4000 may be increased.

The first position sensor 4520 may be disposed at a position enabling the first position sensor 4520 to sense a change in a position of the sensing magnet 4510. In an embodiment, the sensing magnet 4510 and the first position sensor 4520 may be disposed to face each other in the first optical axis (X-axis) direction. In another embodiment, the sensing magnet 4510 and the first position sensor 4520 may be spaced apart from each other in the second optical axis (Z-axis) direction when viewed in the first optical axis (X-axis) direction.

The first position sensor 4520 may be disposed at a position spaced apart from the first coil 4200. The first position sensor 4520 may be a Hall sensor.

When power is applied to the first coil 4200, an error (Hall coupling) may occur in the position of the guide member 3300 sensed by the first position sensor 4520 due to the magnetic field of the first coil 4200. However, according to an embodiment, the camera module 1 may improve an accuracy of sensing of the position of the guide member 3300 since the first position sensor 4520 is spaced apart from the first coil 4200.

In an embodiment, the first position sensor 4520 may be spaced apart from the protrusion RX in the second optical axis (Z-axis) direction.

A second driver 5000 may be provided to rotate the holder 3200. The second driver 5000 may include a second magnet 5100 and a second coil 5200. The holder 3200 may be rotated about the first axis (Y-axis) by the second driver 5000. Since the first lens module 2100 is disposed on the holder 3200, the first lens module 2100 may also rotate together with the holder 3200.

The second magnet 5100 may be mounted on the holder 3200. For example, the second magnet 5100 may be mounted on one side surface of the holder 3200.

The second magnet 5100 may be magnetized so that one surface (e.g., a surface facing the second coil 5200) may have both an N pole and an S pole. In an embodiment, one surface of the second magnet 5100 facing the second coil 5200 may be magnetized with an N pole, a neutral region, and an S pole arranged in order in the first optical axis (X-axis) direction.

The second magnet 5100 may have a shape having a length extending in the first axis (Y-axis) direction. For example, a length in the first axis (Y-axis) direction of the second magnet 5100 may be longer than a width of the second magnet 5100 in the first optical axis (X-axis) direction.

The second coil 5200 may be disposed at a position facing the second magnet 5100. In an embodiment, the second coil 5200 may face the second magnet 5100 in the second optical axis (Z-axis) direction.

The second coil 5200 may include two coils. The two coils may be spaced apart from each other in the first axis (Y-axis) direction.

The second coil 5200 may be disposed on the substrate 9000, and the substrate 9000 may be mounted on the housing 1000 so that the second magnet 5100 and the second coil 5200 may face each other in the second optical axis (Z-axis) direction.

The housing 1000 may include a through-hole passing through the housing 1000 in the second optical axis (Z-axis) direction, and the second coil 5200 may be disposed in the through-hole to directly face the second magnet 5100.

During optical image stabilization, the second magnet 5100 may be configured as a moving member mounted on the holder 3200 and rotating together with the holder 3200, and the second coil 5200 may be a fixed member fixed to the substrate 9000.

When power is applied to the second driver 5000, the second driver 5000 may generate a driving force to rotate the holder 3200 about the first axis (Y-axis) as a rotational axis. The second driver 5000 may generate a driving force in the first optical axis (X-axis) direction.

A second ball member B2 may be disposed between the holder 3200 and the guide member 3300. The second ball member B2 may be disposed between the holder 3200 and the guide member 3300 and may form the rotational axis of the holder 3200.

The second ball member B2 may include a plurality of balls spaced apart from in the first axis (Y-axis) direction.

When viewed in the first axis (Y-axis) direction, one portion of the reflective surface of the reflective member 3100 may overlap the second ball member B2.

A virtual line connecting the plurality of balls of the second ball member B2 to each other in the first axis (Y-axis) direction may pass through the reflective surface of the reflective member 3100.

An attractive force may act between the holder 3200 and the guide member 3300. In an embodiment, a first pulling magnet 5300 may be disposed on one of the holder 3200 and the guide member 3300, and a second pulling yoke 5400 may be disposed on the other one of the holder 3200 and the guide member 3300. In another embodiment, the first pulling magnet 5300 may be disposed on both the holder 3200 and the guide member 3300.

One surface of the first pulling magnet 5300 (e.g., a surface facing the second pulling yoke 5400) may be magnetized with an N pole, a neutral region, and an S pole arranged in order in the first axis (Y-axis) direction.

The first pulling magnet 5300 and the second pulling yoke 5400 may face each other in the second optical axis (Z-axis) direction.

The first pulling magnet 5300 and the second pulling yoke 5400 may generate an attractive therebetween. For example, the second pulling yoke 5400 may be made of a magnetic material. The attractive force may be generated between the first pulling magnet 5300 and the second pulling yoke 5400 in the second optical axis (Z-axis) direction.

The second ball member B2 may be kept in contact with the holder 3200 and the guide member 3300 by the attractive force generated between the first pulling magnet 5300 and the second pulling yoke 5400.

A third guide groove g3 and a fourth guide groove g4 may be formed in surfaces of the holder 3200 and the guide member 3300 facing each other in the second optical axis (Z-axis) direction.

For example, the third guide groove g3 may be formed in a surface of the holder 3200 facing in the second optical axis (Z-axis) direction, and the fourth guide groove g4 may be formed in a surface of the guide member 3300 facing in the second optical axis (Z-axis) direction and facing the surface of the holder 3200 in which the third guide g3 is formed.

The second ball member B2 may be disposed between the third guide groove g3 of the holder 3200 and the fourth guide groove g4 of the guide member 3300, and may form a rotational axis of the holder 3200.

A plurality of balls of the second ball member B2 may be in three-point contact with the third guide groove g3 of the holder 3200, and may be in three-point contact with the fourth guide groove g4 of the guide member 3300.

In an embodiment, the camera module 1 may sense the position of the holder 3200. To this end, a second position sensor 5500 may be provided. The second position sensor 5500 may be disposed at a position facing the second magnet 5100 in the second optical axis (Z-axis) direction. For example, the second position sensor 5500 may be disposed between two coils of the second coil 5200.

Accordingly, when the holder 3200 rotates with the first axis (Y-axis) as the rotational axis, the position of the holder 3200 may be sensed by the second position sensor 5500.

The second position sensor 5500 may be a Hall sensor.

The reflective module 3000 may further include a stopper 7100. The stopper 7100 may be coupled to the guide member 3300 to cover at least a portion of the holder 3200. For example, the stopper 7100 may cover at least a portion of the upper surface of the holder 3200. The stopper 7100 and the holder 3200 may be spaced apart from each other in the first optical axis (X-axis) direction.

Since the stopper 7100 is spaced apart from the holder 3200, the holder 3200 may be prevented from being separated from the guide member 3300 due to external impacts without impeding rotation of the holder 3200.

A buffer member 7200 having elasticity may be coupled to the stopper 7100. The buffer member 7200 may be disposed on at either one or both of one surface and another surface of the stopper 7100 facing the holder 3200.

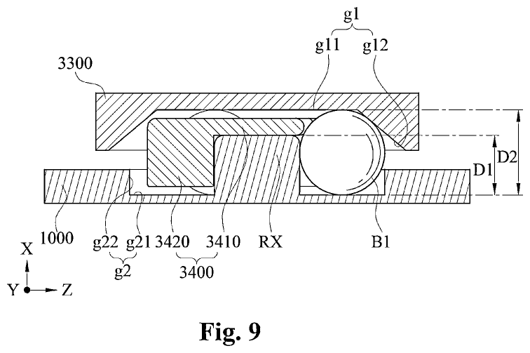

FIG. 8 is a diagram illustrating a support structure of a first ball member of FIGS. 2, 6, and 7, and illustrating the guide member and the housing of FIGS. 6 and 7 in simplified form for ease of illustration. FIG. 9 is a cross-sectional diagram illustrating a state in which components illustrated in FIG. 8 coupled to each other.

Referring to FIG. 8, the first ball member B1 may be disposed between the guide member 3300 and the housing 1000 and may support rotation of the guide member 3300.

The first ball member B1 may include a plurality of balls. The plurality of balls may be spaced apart from each other in the rotational direction of the guide member 3300.

The guide member 3300 may include a first guide groove g1, and the housing 1000 may include a second guide groove g2. The first guide groove g1 and the second guide groove g2 may face each other in the first optical axis (X-axis) direction.

The first ball member B1 may be disposed between the first guide groove g1 and the second guide groove g2.

A protrusion RX may be disposed in the first guide groove g1 or the second guide groove g2. For example, the protrusion RX may protrude from a bottom surface g21 of the second guide groove g2 toward the first guide groove g1. A height (D1, e.g., a length in the first optical axis (X-axis) direction) of the protrusion RX may be smaller than a diameter D2 of each of the plurality of balls of the first ball member B1.

In another embodiment, the protrusion RX may also be disposed in the first guide groove g1. In this case, the protrusion RX may protrude from a bottom surface g11 of the first guide groove g1 toward the second guide groove g2.

The plurality of balls of the first ball member B1 may roll while being in contact with an outer surface of the protrusion RX. Accordingly, the protrusion RX may form a rotational axis of the guide member 3300.

In an embodiment, a retainer 3400 may be disposed between the first guide groove g1 and the second guide groove g2. The retainer 3400 may function to maintain a spacing between the plurality of balls of the first ball member B1.

The retainer 3400 may include a body 3410 and a plurality of supports 3420 extending from the body 3410.

The body 3410 may be in contact with or spaced apart from an upper surface of the protrusion RX. The plurality of supports 3420 may extend from the body 3410 between the plurality of balls. Accordingly, the plurality of supports 3420 may maintain a spacing between the plurality of balls.

Either one or both of a contact surface of the guide member 3300 and a contact surface of the housing 1000 in contact with the plurality of balls of the first ball member B1 may be an inclined surface with respect to the first optical axis (X-axis). The angle between the inclined surface and the first optical axis (X-axis) may be an acute angle.

Referring to FIG. 9, an inner wall surface g12 of the first guide groove g1 may be inclined with respect to the first optical axis (X-axis), and may be curved around the first optical axis (X-axis). As illustrated in FIG. 9, the inner wall surface g12 of the first guide groove g1 may extend obliquely from a bottom surface g11 of the first guide groove g1 in a direction away from the first optical axis (X-axis).

The plurality of balls of the first ball member B1 may be in two-point contact with the guide member 3300, and in two-point contact with the housing 1000.

For example, the plurality of balls of the first ball member B1 may be in contact with the bottom surface g11 of the first guide groove g1 and the inner wall surface g12 of the first guide groove g1.

The plurality of balls of the first ball member B1 may be in contact with the bottom surface g21 of the second guide groove g2 and the outer surface of the protrusion RX.

The first ball member B1 may be disposed between the 1-1 magnet and the 1-2 magnet of FIGS. 6 and 7. That is, the plurality of balls of the first ball member B1 may be disposed in the region in which an attractive force acts between the first pulling yoke 4400 and the 1-1 magnet and the 1-2 magnet. Also, since the entirety of the plurality of balls of the first ball member B1 may roll due to the rotation of the guide member 3300, a pressure applied to the plurality of balls of the first ball member B1 may be uniformly maintained.

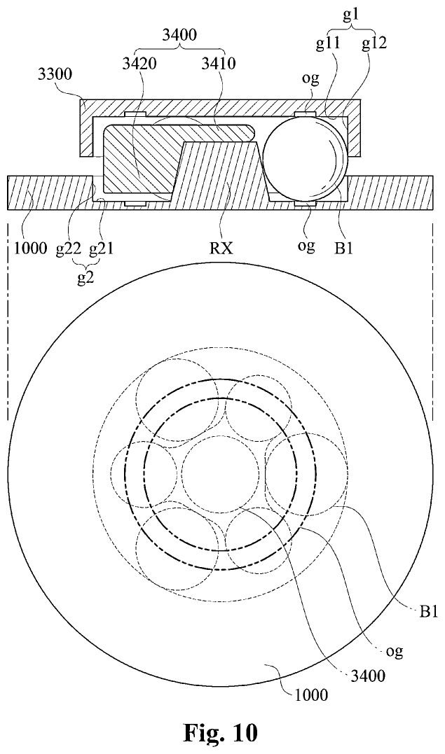

FIG. 10 is a diagram illustrating a modified example of FIG. 9.

The embodiment in FIG. 10 differs from the embodiment in FIG. 9 in terms of the shape of the protrusion RX and the shape of the first guide groove g1.

The protrusion RX may have a truncated cone shape. Accordingly, the outer surface of the protrusion RX may be inclined with respect to the first optical axis (X-axis),

The inner wall surface g12 of the first guide groove g1 may be vertical with respect to the first optical axis (X-axis), and may be curved around the first optical axis (X-axis). For example, the inner wall surface g12 of the first guide groove g1 may extend from the bottom surface g11 of the first guide groove g1 in the first optical axis (X-axis) direction.

The plurality of balls of the first ball member B1 may be in two-point contact with the guide member 3300, and in two-point contact with the housing 1000.

For example, the plurality of balls of the first ball member B1 may be in contact with the bottom surface g11 of the first guide groove g1 and the inner wall surface g12 of the first guide groove g1.

The plurality of balls of the first ball member B1 may be in contact with the bottom surface g21 of the second guide groove g2 and the outer surface of the protrusion RX.

A lubrication groove og may be formed in the first guide groove g1. For example, the lubrication groove og may be formed in the bottom surface g11 of the first guide groove g1. The lubrication groove og may be formed continuously in the rotation direction of the guide member 3300. A lubricant facilitating rolling of the first ball member B1 may be disposed in the lubrication groove og.

A lubrication groove og may also be formed in the second guide groove g2. For example, the lubrication groove og may be formed in the bottom surface g21 of the second guide groove g2. The lubrication groove og may be formed continuously in the rotation direction of the guide member 3300. A lubricant facilitating rolling of the first ball member B1 may be disposed in the lubrication groove og.

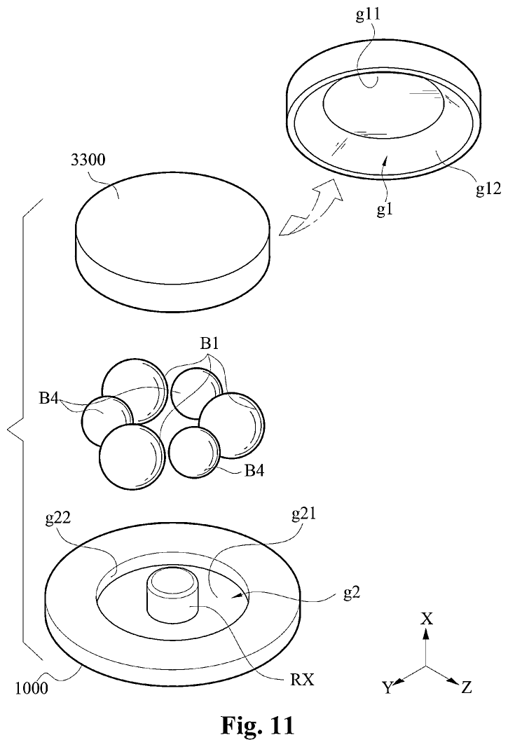

FIG. 11 is a diagram illustrating a first modified example of FIG. 8.

In the embodiment in FIG. 11, a sub-ball member B4 may be provided instead of the retainer 3400. For example, the sub-ball member B4 may be disposed between the plurality of balls of the first ball member B1. The sub-ball member B4 may include a plurality of sub-balls.

A diameter of each of the plurality of sub-balls of the sub-ball member B4 may be smaller than the diameter of each of the plurality of balls of the first ball member B1.

Accordingly, the plurality of sub-balls of the sub-ball member B4 may be in contact with either the guide member 3300 or the housing 1000, and may be spaced apart from each other in the rotational direction of the guide member 3300.

A spacing between the plurality of balls of the first ball member B1 may be maintained by the plurality of sub-balls of the sub-ball member B4.

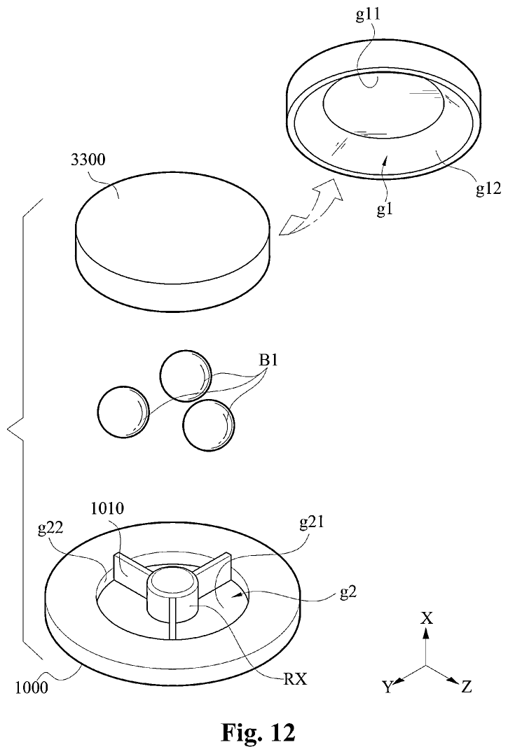

FIG. 12 is a diagram illustrating a second modified example of FIG. 8.

In the embodiment in FIG. 12, a barrier wall 1010 may be disposed in either one or both of the first guide groove g1 and the second guide groove g2.

For example, the barrier wall 1010 may be disposed between the plurality of balls of the first ball member B1 and may protrude in the first optical axis (X-axis) direction from the bottom surface g21 of the second guide groove g2. A height of the barrier wall 1010 in the first optical axis (X-axis) direction may be greater than one half of the diameter of each of the plurality of balls of the first ball member B1.

Accordingly, the plurality of balls of the first ball member B1 may roll in a space defined by the barrier wall 1010.

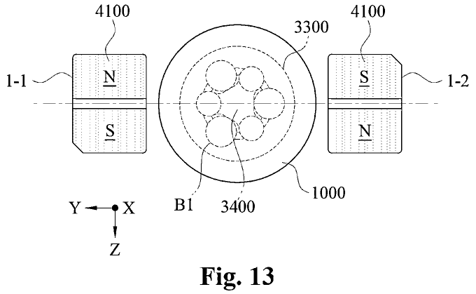

FIGS. 13 to 15 are diagrams illustrating modified examples of a first magnet of FIGS. 6 and 7.

Referring to FIG. 13, the first magnet 4100 may include a 1-1 magnet and a 1-2 magnet. The 1-1 magnet and the 1-2 magnet may be spaced apart from each other in the first axis (Y-axis) direction.

The 1-1 magnet and 1-2 magnet may have a shape having a length extending in the second optical axis (Z-axis) direction.

The first ball member B1 may be disposed between the 1-1 magnet and the 1-2 magnet.

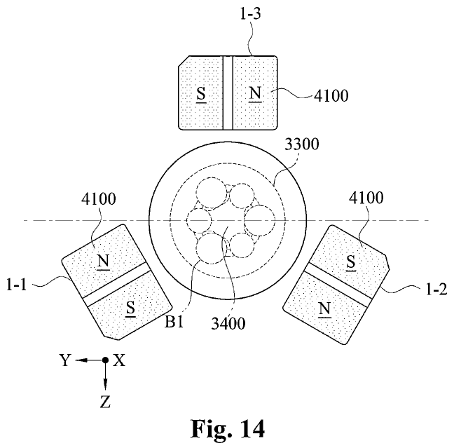

Referring to FIG. 14, the first magnet 4100 may include a 1-1 magnet, a 1-2 magnet, and a 1-3 magnet. The 1-1 magnet to the 1-3 magnet may be spaced apart from each other at vertices of an equilateral triangle.

The first ball member B1 may be disposed in a space surrounded by the 1-1 magnet to the 1-3 magnet.

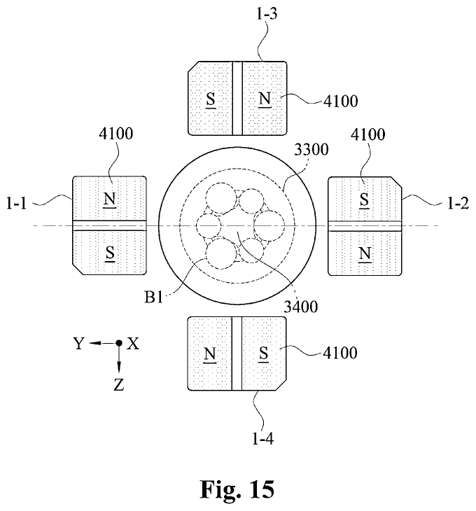

Referring to FIG. 15, the first magnet 4100 may include a 1-1 magnet, a 1-2 magnet, a 1-3 magnet and a 1-4 magnet. The 1-1 magnet and the 1-2 magnet may be spaced apart from each other in the first axis (Y-axis) direction. The 1-3 magnet and the 1-4 magnet may be spaced apart from each other in the second optical axis (Z-axis) direction.

The first ball member B1 may be disposed in a space surrounded by the 1-1 magnet to the 1-4 magnet.

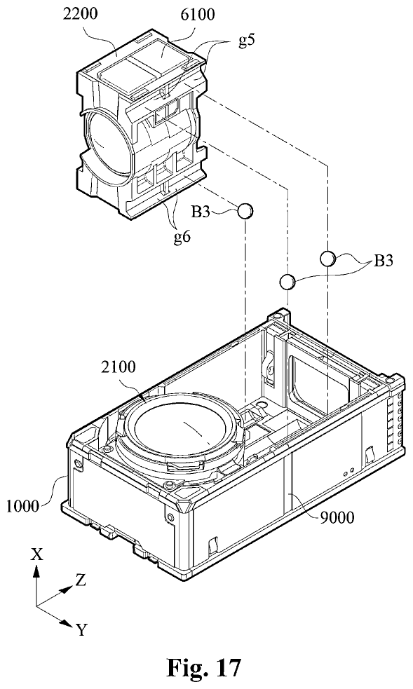

FIGS. 16 and 17 are perspective diagrams illustrating a second lens module of FIG. 2 separated from the camera module of FIG. 1.

Referring to FIG. 16 and FIG. 17, a second lens module 2200 may be disposed between the reflective module 3000 and the image sensor module 8000.

The second lens module 2200 may move in the second optical axis (Z-axis) direction for focus adjustment.

In an embodiment, the second lens module 2200 may include a second lens barrel 2210 and a carrier 2220. A plurality of lenses may be disposed in the second lens barrel 2210, and the second lens barrel 2210 may be coupled to the carrier 2220.

The camera module 1 of FIG. 1 may include a third driver 6000 to move the second lens module 2200 in the second optical axis (Z-axis) direction.

The third driver 6000 may include a third magnet 6100 and a third coil 6200. The third magnet 6100 and the third coil 6200 may be disposed to face each other in a direction perpendicular to the second optical axis (Z-axis) direction.

The third magnet 6100 may be mounted on the second lens module 2200. For example, the third magnet 6100 may be disposed on one side surface of the second lens module 2200 (e.g., one side surface of the carrier 2220).

In an embodiment, the second lens module 2200 may include one side surface and another side surface spaced apart from each other in the first axis (Y-axis) direction. Also, the third magnet 6100 may be disposed on the one side surface of the second lens module 2200.

The third magnet 6100 may be magnetized so that one surface (e.g., the surface facing the third coil 6200) may have both an N pole and an S pole. For example, the one surface of the third magnet 6100 facing the third coil 6200 may have an N pole, a neutral region, and an S pole arranged in order in the second optical axis (Z-axis) direction.

The third coil 6200 may be disposed to face the third magnet 6100. For example, the third coil 6200 may be disposed to face the third magnet 6100 in a direction (e.g., the first axis (Y-axis) direction) perpendicular to the second optical axis (Z-axis) direction.

The third coil 6200 may be disposed on the substrate 9000, and the substrate 9000 may be mounted on the housing 1000 so that the third magnet 6100 and the third coil 6200 may face each other in the first axis (Y-axis) direction.

The housing 1000 may include a through-hole passing through the housing 1000, and the third coil 6200 disposed on the substrate 9000 may directly face the third magnet 6100 through the through-hole.

During focus adjustment, the third magnet 6100 may be configured as a moving member mounted on the second lens module 2200 and moving in the second optical axis (Z-axis) direction together with the second lens module 2200, and the third coil 6200 may be a fixed member fixed to the substrate 9000.

When power is applied to the third coil 6200, the second lens module 2200 may be moved in the second optical axis (Z-axis) direction by an electromagnetic force generated between the third magnet 6100 and the third coil 6200.

A third ball member B3 may be disposed between the second lens module 2200 and the housing 1000, and the second lens module 2200 may be guided by the third ball member B3 and may move in the second optical axis (Z-axis) direction. The third ball member B3 may include a plurality of balls.

A second pulling magnet 6300 may be disposed on a lower surface of the second lens module 2200, and a third pulling yoke 6400 may be disposed on an internal bottom surface of the housing 1000. In another embodiment, the second pulling magnet 6300 may be disposed on both the second lens module 2200 and the housing 1000.

The second pulling magnet 6300 may be disposed closer to the one side surface of the second lens module 2200. That is, the second pulling magnet 6300 may be disposed closer to the one side surface of the second lens module 2200 than to the other side surface of the second lens module 2200. Also, the second pulling magnet 6300 may be disposed between the one side surface of the second lens module 2200 and the second optical axis (Z-axis).

The second pulling magnet 6300 and the third pulling yoke 6400 may be disposed to face each other in the first optical axis (X-axis) direction.

The second pulling magnet 6300 and the third pulling yoke 6400 may generate an attractive force therebetween. For example, attractive force may act in the first optical axis (X-axis) direction between the second pulling magnet 6300 and the third pulling yoke 6400.

The third ball member B3 may be kept in contact with the second lens module 2200 and the housing 1000 by the attractive force generated between the second pulling magnet 6300 and the third pulling yoke 6400.

A portion of the plurality of balls of the third ball member B3 may be disposed closer to the one side surface of the second lens module 2200 than the other side surface of the second lens module 2200, and a remaining portion of the plurality of balls of the third ball member B3 may be disposed closer to the other side surface of the second lens module 2200 than the one side surface of the second lens module 2200.

The number of balls disposed between the one side surface of the second lens module 2200 and the second optical axis (Z-axis) may be greater than the number of balls disposed between the other side surface of the second lens module 2200 and the second optical axis (Z-axis).

In an embodiment, the third ball member B3 may include three balls. Two of the three balls may be disposed between the one side surface of the second lens module 2200 and the second optical axis (Z-axis), and the other one of the three balls may be disposed between the other side surface of the second lens module 2200 and the second optical axis (Z-axis).

The two balls disposed between the one side surface of the second lens module 2200 and the second optical axis (Z-axis) may be spaced apart from each other in the second optical axis (Z-axis) direction.

A fifth guide groove g5 and a sixth guide groove g6 may be formed in a surface of the second lens module 2200 facing the housing 1000. For example, the fifth guide groove g5 may be formed at one side of the surface of the second lens module 2200 facing the housing 1000, and the sixth guide groove g6 may be formed at another side of the surface of the second lens module 2200 facing the housing 1000.

The fifth guide groove g5 and the sixth guide groove g6 may be spaced apart from each other in the first axis (Y-axis) direction.

The fifth guide groove g5 and the sixth guide groove g6 may extend in a direction parallel to the second optical axis (Z-axis).

A portion of the plurality of balls of the third ball member B3 may be disposed in the fifth guide groove g5, and a remaining portion of the plurality of balls of the third ball member B3 may be disposed in the sixth guide groove g6.

The number of contact points between the portion of the plurality of balls of the third ball member B3 and the fifth guide groove g5 may be greater than the number of contact points between the remaining portion of the plurality of balls of the third ball member B3 and the sixth guide groove g6.

The fifth guide groove g5 may be disposed closer to the one side surface of the second lens module 2200 than the sixth guide groove g6.

The second pulling magnet 6300 may be disposed closer to the fifth guide groove g5 than to the sixth guide groove g6.

In an embodiment, the camera module 1 may sense a position of the second lens module 2200. To this end, a third position sensor 6500 may be provided. The third position sensor 6500 may be disposed at a position facing the third magnet 6100 of the third driver 6000 in the first axis (Y-axis) direction.

Accordingly, when the second lens module 2200 moves in the second optical axis (Z-axis) direction, the position of the second lens module 2200 may be sensed by the third position sensor 6500.

The third position sensor 6500 may be a Hall sensor.

Although not illustrated in FIGS. 1 to 17, at least one lens (hereinafter referred to as a “calibration lens”) may be coupled to the reflective member 3100 of the reflective module 3000. The calibration lens may have a positive refractive power.

In an embodiment, an exit surface of the reflective member 3100 of the reflective module 3000 and an object-side surface of the calibration lens may be bonded to each other.

Accordingly, when the reflective module 3000 rotates, the calibration lens may also rotate together with the reflective module 3000.

In the embodiment, when a calibration lens having a positive refractive power is disposed on the exit surface of the reflective member 3100 of the reflective module 3000, an error in an optical path occurring during optical image stabilization may be compensated, so that a high-quality image may be captured.

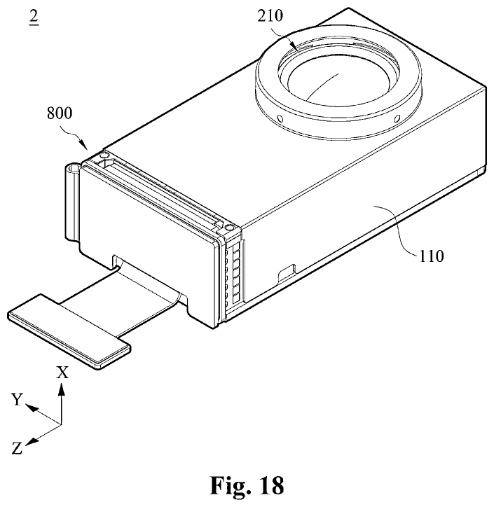

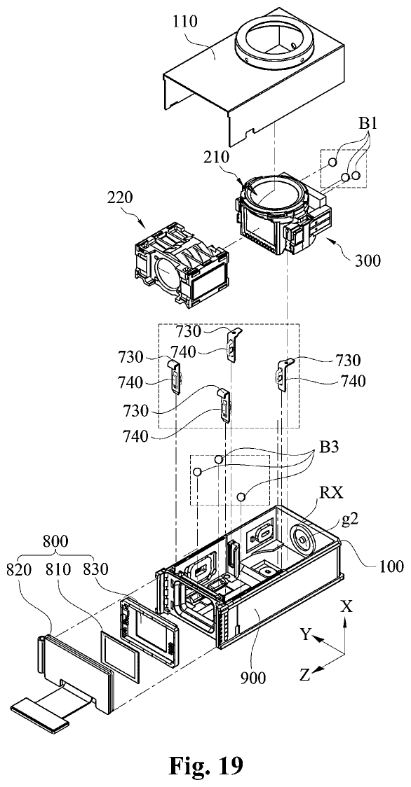

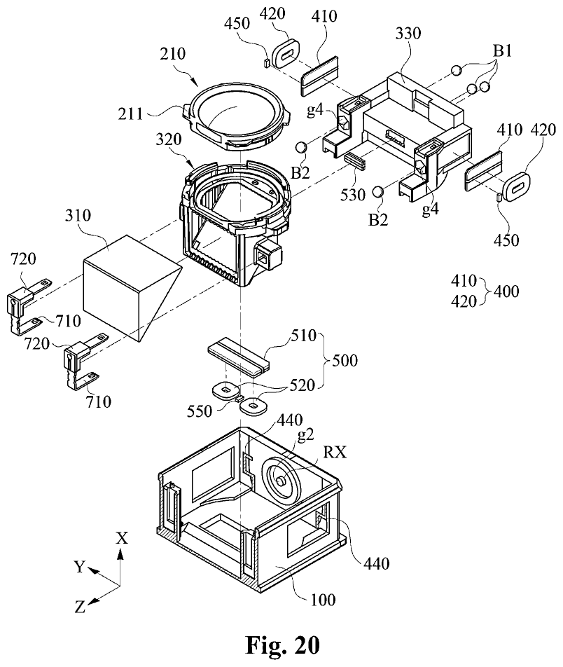

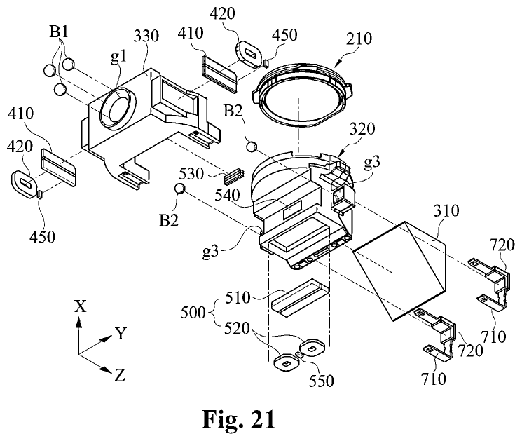

FIG. 18 is a perspective diagram illustrating a camera module according to another embodiment of the present disclosure. FIG. 19 is an exploded perspective diagram illustrating the camera module of FIG. 18. FIG. 20 is an exploded perspective diagram illustrating a reflective module of FIG. 19. FIG. 21 is an exploded perspective diagram illustrating a holder and a guide member of the reflective module of FIG. 320 viewed from below.

Referring to FIGS. 18 to 21, a camera module 2 according to another embodiment may include a first lens module 210, a reflective module 300, a second lens module 220, and a housing 100.

The first lens module 210 may include at least one lens and a first lens barrel 211. The at least one lens may have a first optical axis (X-axis) and may be mounted on the first lens barrel 211. The first optical axis (X-axis) may extend in a vertical direction with reference to FIG. 20.

The first lens module 210 may be disposed on a front side of the reflective module 300. The “front side of the reflective module 300” may refer to a positive first optical axis (X-axis) direction (+X-axis direction) with respect to the reflective module 300. For example, the first lens module 210 may be disposed above the reflective module 300 in the first optical axis (X-axis) direction.

The first lens module 210 may be coupled to the reflective module 300. For example, the first lens module 210 may be coupled to a holder 320 of the reflective module 300.

The reflective module 300 may include a reflective member 310, and the reflective member 310 may have a reflective surface reflecting light passing through the first lens module 210. For example, the reflective member 310 may be a prism or a mirror. The reflective member 310 may be coupled to the holder 320.

The first lens module 210 and the reflective module 300 may be disposed in the housing 100.

In an embodiment, the camera module 2 may further include a second lens module 220. The reflective module 300 may be disposed between the first lens module 210 and the second lens module 220. The second lens module 220 may include a plurality of lenses and a second lens barrel. The plurality of lenses may have a second optical axis (Z-axis) and may be mounted on the second lens barrel.

The first optical axis (X-axis) of the first lens module 210 and the second optical axis (Z-axis) of the second lens module 220 may be perpendicular to each other.

The first lens module 210 may include one or more lenses, and the second lens module 220 may include a plurality of lenses.

The one or more lenses of the first lens module 210 may have a circular shape when viewed in the first optical axis (X-axis) direction. At least one lens among the plurality of lenses of the second lens module 220 may have a non-circular shape when viewed in the second optical axis (Z-axis) direction. For example, the non-circular lens may have different dimensions in two directions perpendicular to the second optical axis (Z-axis) direction and perpendicular to each other. In an embodiment, a length in the first axis (Y-axis) direction of the non-circular lens, perpendicular to both the first optical axis (X-axis) direction and the second optical axis (Z-axis) direction, may be greater than a width of the non-circular lens in the first optical axis (X-axis) direction.

Although the camera module 2 includes the first lens module 210 and the second lens module 220, it is not limited thereto, and the camera module 2 may include only one of the first lens module 210 and the second lens module 220.

In an embodiment, the first lens module 210 and the reflective member 310 may be configured to rotate together for optical image stabilization. That is, the first lens module 210 and the reflective member 310 may rotate together about two axes perpendicular to each other.

For example, the first lens module 210 and the reflective member 310 may rotate together about the second optical axis (Z-axis) as a rotational axis, and may rotate together about the first axis (Y-axis) perpendicular to both the first optical axis (X-axis) and the second optical axis (Z-axis) as a rotational axis.

In an embodiment, the second lens module 220 may move in the second optical axis (Z-axis) direction for focus adjustment.

The camera module 2 may further include an image sensor module 800.

The image sensor module 800 may include a sensor housing 830, an image sensor 810, and a printed circuit board 820, and may further include an infrared cut-off filter (not shown).

The infrared cut-off filter may be mounted on the sensor housing 830. The infrared cut-off filter may block light in the infrared region.

The printed circuit board 820 may be coupled to the sensor housing 830, and the image sensor 810 may be mounted on the printed circuit board 820.

Light passing through the second lens module 220 may be received by the image sensor module 800 (e.g., the image sensor 810).

The camera module 2 may further include a case 110. The case 110 may be coupled to the housing 100 to cover an upper portion of the housing 100. The case 110 may include an opening, and the first lens module 210 may be disposed in the opening.

At least a portion of the first lens module 210 may protrude externally from the housing 100.

The reflective module 300 may include the reflective member 310, the holder 320, and a guide member 330.

The reflective member 310 may have a reflective surface reflecting light passing through the first lens module 210. For example, the reflective member 310 may be a prism or a mirror.

When the reflective member 310 is a prism, the reflective member 310 may have a shape of a rectangular solid or a cube divided into two halves in a diagonal direction. The prism may include an incident surface to which light is incident, a reflective surface reflecting light passing through the incident surface, and an exit surface through which light reflected from the reflective surface is emitted.

The reflective member 310 may be mounted on the holder 320. The first lens module 210 may be disposed on the front side of the reflective member 310. In an embodiment, the first lens module 210 may be mounted on the holder 320.

The holder 320 may be disposed on the guide member 330 and may rotate. Also, the guide member 330 may be disposed on the housing 100 and may rotate

The guide member 330 may rotate about the second optical axis (Z-axis) as a rotational axis. For example, the guide member 330 may rotate relative to the housing 100 about the second optical axis (Z-axis) as the rotational axis. In this case, the first lens module 210 and the holder 320 may rotate together with the guide member 330. The second optical axis (Z-axis) may also be referred to as a first rotational axis.

The holder 320 may rotate about the first axis (Y-axis) perpendicular to both the first optical axis (X-axis) and the second optical axis (Z-axis) as a rotational axis. For example, the holder 320 may rotate relative to the guide member 330 about the first axis (Y-axis) as the rotational axis. In this case, the first lens module 210 may rotate together with the holder 320. The first axis (Y-axis) may also be referred to as a second rotational axis.

A first driver 400 may be provided to rotate the reflective module 300. The first driver 400 may include a first magnet 410 and a first coil 420. The guide member 330 may be rotated relative to the housing 100 about the second optical axis (Z-axis) by the first driver 400. Since the holder 320 and the first lens module 210 are disposed on the guide member 330, the holder 320 and the first lens module 210 may also rotate together with the guide member 330.

The first magnet 410 may be mounted on the guide member 330. For example, the first magnet 410 may be mounted on a first side surface and a second side surface of the guide member 330. The first side surface and the second side surface of the guide member 330 may be spaced apart from each other in the first axis (Y-axis) direction.

The first magnet 410 may be magnetized so that one surface (e.g., a surface facing the first coil 420) may have a first polarity and a second polarity. The first polarity and the second polarity may be opposite polarities, and when the first polarity is an N pole, the second polarity may be an S pole.

In an embodiment, one surface of the first magnet 410 facing the first coil 420 may have a first polarity and a second polarity arranged in the first optical axis (X-axis) direction, and a neutral region may be disposed between the first polarity and the second polarity.

The first coil 420 may be disposed at a position facing the first magnet 410. In an embodiment, the first coil 420 may be disposed to face the first magnet 410 in the first axis (Y-axis) direction.

The first coil 420 may be disposed on a substrate 900, and the substrate 900 may be mounted on the housing 100 so that the first magnet 410 and the first coil 420 may face each other in the first axis (Y-axis) direction.

The housing 100 may include a through-hole passing through the housing 100 in the first axis (Y-axis) direction, and the first coil 420 may be disposed in the through-hole and may directly face the first magnet 410.

The first coil 420 may include two coils. The two coils may be spaced apart from each other in the first axis (Y-axis) direction.

During optical image stabilization, the first magnet 410 may be configured as a moving member mounted on the guide member 330 and rotating together with the guide member 330, and the first coil 420 may be configured as a fixed member fixed to the substrate 900.

When power is applied to the first driver 400, the first driver 400 may generate a driving force to rotate the guide member 330 about the second optical axis (Z-axis) as a rotational axis. For example, the first driver 400 may generate a driving force in the first optical axis (X-axis) direction.

A first ball member B1 may be disposed between the guide member 330 and the housing 100. The first ball member B1 may include a plurality of balls.

Either the guide member 330 or the housing 100 may include a protrusion RX. For example, the housing 100 may include a protrusion RX. In an embodiment, the protrusion RX may protrude from an inner surface of the housing 100 in the second optical axis (Z-axis) direction. A virtual line formed by extending the second optical axis (Z-axis) of the second lens module 220 may pass through the protrusion RX. The inner surface of the housing 100 may be a plane perpendicular to the second optical axis (Z-axis).

The protrusion RX may form a rotational axis of the guide member 330.

The plurality of balls of the first ball member B1 may be disposed around the protrusion RX. For example, the plurality of balls may be in contact with an outer surface of the protrusion RX.

A height of the protrusion RX (e.g., a length of the protrusion RX in the second optical axis (Z-axis) direction) may be smaller than a diameter of each of the plurality of balls of the first ball member B1.

An attractive force may act between the guide member 330 and the housing 100. In an embodiment, a first pulling yoke 440 may be disposed at a position facing the first magnet 410 in the second optical axis (Z-axis) direction.

The first pulling yoke 440 may be disposed on an inner surface of the housing 100. In an embodiment, at least a portion of the first pulling yoke 440 may have a shape that is not a straight line. That is, the first pulling yoke 440 may have a length in the first optical axis (X-axis) direction and at least a portion thereof may be bent. For example, the first pulling yoke 440 may have a meandering shape.

The first pulling yoke 440 may include a plurality of first pulling yokes, and the plurality of first pulling yokes of the first pulling yoke 440 may be spaced apart from each other in the first axis (Y-axis) direction.

The first magnet 410 and the first pulling yoke 440 may generate an attractive force therebetween. For example, the first pulling yoke 440 may be made of a magnetic material. The attractive force may be generated between the first magnet 410 and the first pulling yoke 440 in the second optical axis (Z-axis) direction.

The first ball member B1 may be kept in contact with the guide member 330 and the housing 100 by the attractive force generated between the first magnet 410 and the first pulling yoke 440.

The first ball member B1 may be disposed between the plurality of first pulling yokes of the first pulling yoke 440. That is, the plurality of balls of the first ball member B1 may be disposed in a region in which the attractive force acts between the first pulling yoke 440 and the first magnet 410. Also, since the entirety of the plurality of balls of the first ball member B1 roll by rotation of the guide member 330, a pressure applied to the plurality of balls of the first ball member B1 may be maintained uniformly.

A first guide groove g1 may be formed in the guide member 330. For example, the first guide groove g1 may be formed in a third side surface of the guide member 330. The third side surface of the guide member 330 may be perpendicular to the second optical axis (Z-axis). Also, the first guide groove g1 may face the inner surface of the housing 100.

A planar shape of the first guide groove g1 may be circular. For example, an inner wall surface of the first guide groove g1 may be curved.

A second guide groove g2 may be formed in the housing 100. For example, the second guide groove g2 may be formed in the inner surface of the housing 100. Also, the second guide groove g2 may face the first guide groove g1.

A planar shape of the second guide groove g2 may be circular. For example, an inner wall surface of the second guide groove g2 may be curved. Also, the protrusion RX may protrude from a bottom surface of the second guide groove g2 in the second optical axis (Z-axis) direction. At least a portion of the protrusion RX may protrude externally from the second guide groove g2.

The first guide groove g1 and the second guide groove g2 may face each other in the second optical axis (Z-axis) direction.

The first ball member B1 may be disposed around the protrusion RX to be in contact with the outer surface of the protrusion RX, and may be disposed between the first guide groove g1 and the second guide groove g2.

The guide member 330 may be rotated about the second optical axis (Z-axis) by the driving force generated by the first driver 400, and in this case, the first ball member B1 may roll around the protrusion RX between the first guide groove g1 and the second guide groove g2.

In an embodiment, a retainer, a sub-ball member, or a barrier wall (not shown) may be disposed between the first guide groove g1 and the second guide groove g2. The retainer, the sub-ball member, or the barrier wall may have a function of maintaining a spacing between the plurality of balls of the first ball member B1.

Since the retainer, the sub-ball member, or the barrier wall is the same as the retainer, the sub-ball member, or the barrier wall described with reference to FIGS. 8 to 12, a detailed description thereof has been omitted.

A second driver 500 may be provided to rotate the holder 320. The second driver 500 may include a second magnet 510 and a second coil 520. The holder 320 may be rotated about the first axis (Y-axis) by the second driver 500. Since the first lens module 210 is disposed on the holder 320, the first lens module 210 may also rotate together with the holder 320.

The second magnet 510 may be mounted on the holder 320. For example, the second magnet 510 may be mounted on a lower surface of the holder 320.

The second magnet 510 may be magnetized so that one surface (e.g., a surface facing the second coil 520) may have both an N pole and an S pole. In an embodiment, one surface of the second magnet 510 facing the second coil 520 may have an N pole, a neutral region, and an S pole arranged in order in the second optical axis (Z-axis) direction.

The second magnet 510 may have a shape having a length extending in the first axis (Y-axis) direction. For example, a length in the first axis (Y-axis) direction of the second magnet 510 may be longer than a width in the second optical axis (Z-axis) direction of the second magnet 510.

The second coil 520 may be disposed at a position facing the second magnet 510. In an embodiment, the second coil 520 may be disposed to face the second magnet 510 in the first optical axis (X-axis) direction.

The second coil 520 may include two coils. The two coils may be spaced apart from each other in the first axis (Y-axis) direction.

The second coil 520 may be disposed on the substrate 900, and the substrate 900 may be mounted on the housing 100 so that the second magnet 510 and the second coil 520 may face each other the first optical axis (X-axis) direction.

The housing 100 may include a through-hole passing through the housing 100 in the first optical axis (X-axis) direction, and the second coil 520 may be disposed in the through-hole and may directly face the second magnet 510.

During optical image stabilization, the second magnet 510 may be a moving member mounted on the holder 320 and rotating together with the holder 320, and the second coil 520 may be a fixed member fixed to the substrate 900

When power is applied to the second driver 500, the second driver 500 may generate a driving force to rotate the holder 320 about the first axis (Y-axis) as a rotational axis. The second driver 500 may generate the driving force in the second optical axis (Z-axis) direction.

A second ball member B2 may be disposed between the holder 320 and the guide member 330. The second ball member B2 may be disposed between the holder 320 and the guide member 330 and may form a rotational axis of the holder 320.

The second ball member B2 may include a plurality of balls spaced apart from each other in the first axis (Y-axis) direction.

When viewed in the first axis (Y-axis) direction, one portion of the reflective surface of the reflective member 310 may overlap the second ball member B2.

A virtual line connecting the plurality of balls of the second ball member B2 to each other in the first axis (Y-axis) direction may pass through the reflective surface of the reflective member 310.

An attractive force may act between the holder 320 and the guide member 330. In an embodiment, the first pulling magnet 530 may be disposed on one of the holder 320 and the guide member 330, and a second pulling yoke 540 may be disposed on the other one of the holder 320 and the guide member 330. In another embodiment, the first pulling magnet 530 may be disposed on both the holder 320 and the guide member 330.

One surface (e.g., a surface facing the second pulling yoke 540) of the first pulling magnet 530 may be magnetized with an N pole, a neutral region, and an S pole arranged in order in the first optical axis (X-axis) direction.

The first pulling magnet 530 and the second pulling yoke 540 may face each other in the second optical axis (Z-axis) direction.

The first pulling magnet 530 and the second pulling yoke 540 may generate an attractive therebetween. For example, the second pulling yoke 540 may be made of a magnetic material. The attractive force may be generated between the first pulling magnet 530 and the second pulling yoke 540 in the second optical axis (Z-axis) direction.

The second ball member B2 may be kept in contact with the holder 320 and the guide member 330 by the attractive force generated between the first pulling magnet 530 and the second pulling yoke 540.

A third guide groove g3 and a fourth guide groove g4 may be formed in surfaces of the holder 320 and the guide member 330 facing each other in the second optical axis (Z-axis) direction.

For example, the third guide groove g3 may be formed in a surface of the holder 320 facing in the second optical axis (Z-axis) direction, and the fourth guide groove g4 may be formed in a surface the guide member 330 facing in the second optical axis (Z-axis) direction and facing the surface of the holder 320 in which the third guide groove g3 is formed.

The second ball member B2 may be disposed between the third guide groove g3 of the holder 320 and the fourth guide groove g4 of the guide member 330, and may form a rotational axis of the holder 320.

The plurality of balls of the second ball member B2 may be in three-point contact with the third guide groove g3 of the holder 320, and in three-point contact with the fourth guide groove g4 of the guide member 330.

The reflective module 300 may further include a first stopper 710. The first stopper 710 may be coupled to the guide member 330 to cover at least a portion of the holder 320. For example, the first stopper 710 may cover at least a portion of an upper surface of the holder 320. The first stopper 710 and the holder 320 may be spaced apart from each other in the first optical axis (X-axis) direction.

Since the first stopper 710 is spaced apart from the holder 320, the holder 320 may be prevented from being separated from the guide member 330 due to external impacts without impeding rotation of the holder 320.

A buffer member 720 having elasticity may be coupled to the first stopper 710. The buffer member 720 may be disposed on either one or both of one surface and another surface of the first stopper 710 facing the holder 320.

The camera module 2 may further include a second stopper 730. The second stopper 730 may be coupled to the housing 100 and may be disposed at a position facing the second lens module 220 in the second optical axis (Z-axis) direction.

For example, the second stopper 730 may be disposed at a position facing the second lens module 220 in the positive second optical axis (Z-axis) direction and the negative second optical axis (Z-axis) direction.

A buffer member 740 having elasticity may be coupled to the second stopper 730. For example, the second stopper 730 may have a surface facing the second lens module 220 in the second optical axis (Z-axis) direction, and the buffer member 740 may be mounted on the surface of the second stopper 730 facing the second lens module 220 in the second optical axis (Z-axis) direction.

The configuration of the second lens module 220, a first position sensor 450, a second position sensor 550, a third ball member B3, a third driver to move the second lens module 220 in the second optical axis (Z-axis) direction (not shown), and a third position sensor (not shown) may be the same as the second lens module 2200, the first position sensor 4520, the second position sensor 550, the third ball member B3, the third driver 6000, and the third position sensor 6500 in the embodiments described with reference to FIGS. 1 to 17, so that a detailed description thereof has been omitted.

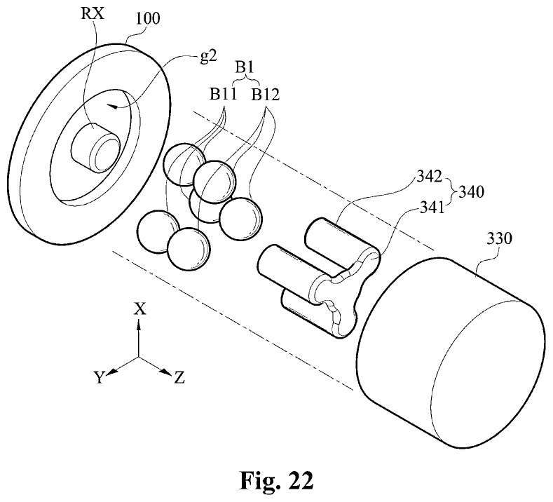

FIG. 22 is a diagram illustrating an example of a support structure of a first ball member illustrated in FIGS. 20 and 21, and illustrating a guide member and a housing of FIGS. 20 and 21 in simplified form for ease of illustration.

Referring to FIG. 22, the first ball member B1 may be disposed between the guide member 330 and the housing 100 and may support rotation of the guide member 300.

The first ball member B1 may include two sets of a plurality of balls. For example, the first ball member B1 may include a ball member B11 and a ball member B12, and the ball member B11 and the ball member B12 may be disposed in the direction (e.g., the second optical axis (Z-axis) direction) in which the protrusion RX protrudes.

Each of the ball member B11 and the ball member B12 may include a plurality of balls disposed around the protrusion RX and spaced apart from each other in the rotational direction of the guide member 330.

The diameter of the plurality of balls of the ball member B11 and the diameter of the plurality of balls of the ball member B12 may be the same.

The ball member B11 and the ball member B12 may be disposed between the first guide groove g1 (not shown in FIG. 22) in the guide member 330 and the second guide groove g2 in the housing 100.

The protrusion RX may be disposed in the first guide groove g1 or the second guide groove g2. For example, the protrusion RX may protrude from the bottom surface of the second guide groove g2 toward the first guide groove g1. A height (e.g., a length in the second optical axis (Z-axis) direction) of the protrusion RX may be greater than a diameter of each ball of the ball member B11 and may be less than twice the diameter of each ball of the ball member B11.

The plurality of balls of the ball member B11 and the plurality of balls of the ball member B12 may be in contact with the outer surface of the protrusion RX and may roll in the rotational direction of the guide member 330. Accordingly, the protrusion RX may form a rotational axis of the guide member 330.

In an embodiment, a retainer 340 may be disposed between the first guide groove g1 and the second guide groove g2. The retainer 340 may function to maintain a spacing between the plurality of balls of the first ball member B1.

The retainer 340 may include a body 341 and a plurality of supports 342 extending from the body 341 in the second optical axis (Z-axis) direction).

The body 341 may be disposed to be in contact with or spaced apart from an upper surface of the protrusion RX. The plurality of supports 342 may extend from the body 341 between the plurality of balls of the ball member B11 and between the plurality of balls of the ball member B12. Accordingly, the plurality of supports 342 may maintain a spacing between the plurality of balls of the first ball member B1.

According to the aforementioned embodiments, the optical module and the camera module including the optical module may improve an optical image stabilization performance.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical module comprising:
a housing;
a guide member disposed in the housing and configured to be rotatable about a first rotational axis;
an optical member configured to be rotatable about the first rotational axis together with the guide member;
a first ball member disposed between the housing and the guide member and comprising a plurality of balls; and
a protrusion disposed on the housing or the guide member and protruding in a direction of the first rotational axis,
wherein the plurality of balls of the first ball member are configured to roll while being in contact with an outer surface of the protrusion.

2. The optical module of claim 1, wherein the plurality of balls of the first ball member are in contact with both the housing and the guide member, and
either one or both of a surface of the housing in contact with the plurality of balls and a surface of the guide member in contact with the plurality of balls is inclined with respect to the first rotational axis.

3. The optical module of claim 1, wherein the protrusion has a truncated cone shape having a cross-sectional area that changes in a direction of the first rotational axis.

4. The optical module of claim 1, wherein the plurality of balls of the first ball member are in two-point contact with the housing, and in two-point contact with the guide member.

5. The optical module of claim 1, wherein a length of the protrusion in the direction of the first rotational axis is smaller than a diameter of each of the plurality of balls of the first ball member.

6. The optical module of claim 1, further comprising a retainer disposed to be rotatable with respect to the protrusion,
wherein the retainer comprises a body and a support extending from the body, and
the support is disposed between the plurality of balls of the first ball member.

7. The optical module of claim 1, further comprising a sub-ball member comprising a plurality of sub-balls each having a diameter smaller than a diameter of each of the plurality of balls,
wherein the plurality of sub-balls of the sub-ball member are disposed between the plurality of balls of the first ball member.

8. The optical module of claim 1, further comprising a first magnet disposed on the guide member and comprising a 1-1 magnet and a 1-2 magnet,
wherein the 1-1 magnet and the 1-2 magnet are spaced apart from each other in a direction perpendicular to a direction of the first rotational axis, and
the first ball member is disposed between the 1-1 magnet and the 1-2 magnet.

9. The optical module of claim 8, further comprising a first coil disposed on the housing and facing one surface of the first magnet,
wherein the one surface of the first magnet comprises an N pole and an S pole spaced apart from each other in a direction perpendicular to the direction of the first rotational axis.

10. The optical module of claim 8, further comprising a first pulling yoke disposed on the housing and spaced apart from the first magnet in the direction of the first rotational axis.

11. The optical module of claim 1, further comprising a lens module having an optical axis,
wherein the optical member is a reflective member comprising a reflective surface configured to reflect light,
the lens module is disposed so that light reflected from the reflective member is incident on the lens module in an optical axis direction of the lens module, and
the optical module further comprises:
a sensing magnet disposed on the guide member and spaced apart from the protrusion in the optical axis direction of the lens module, and
a first position sensor disposed on the housing and facing the sensing magnet.

12. The optical module of claim 1, further comprising:
a holder on which the optical member is mounted, the holder being configured to be rotatable with respect to the guide member about a second rotational axis perpendicular to the first rotational axis;
a second magnet disposed on the holder; and
a second coil facing the second magnet.

13. The optical module of claim 12, further comprising a lens module having an optical axis,
wherein the optical member is a reflective member comprising a reflective surface configured to reflect light,
the lens module is disposed so that light reflected from the reflective member is incident on the lens module in an optical axis direction of the lens module, and
the optical module further comprises a second position sensor disposed on the housing and facing the second magnet so that a virtual line formed by extending the optical axis of the lens module passes through the second position sensor.

14. The optical module of claim 12, further comprising a second ball member disposed between the holder and the guide member and comprising a plurality of balls spaced apart from each other in a direction of the second rotational axis.

15. A camera module comprising:
a holder;
a reflective member disposed on the holder and configured to reflect light;
a guide member on which the holder is disposed;
a housing in which the holder and the guide member are disposed;
a first ball member disposed between the guide member and the housing and comprising a plurality of balls; and
a first lens module having a first optical axis and on which light reflected from the reflective member is incident,
wherein the guide member is configured to be rotatable together with the holder about a first rotational axis,
the holder is configured to be rotatable relative to the guide member about a second rotational axis perpendicular to the first rotational axis,
one of the housing and the guide member comprises a protrusion protruding in a direction of the first rotational axis, and another one of the housing and the guide member comprises a guide groove,
the plurality of balls of the first ball member are in contact with a surface of the protrusion and a surface of the guide groove, and
either one or both of the surface of the protrusion in contact with the plurality of balls of the first ball member and the surface of the guide groove in contact with the plurality of balls of the first ball member is an inclined surface that is inclined with respect to the first rotational axis.

16. The camera module of claim 15, further comprising a first magnet comprising two magnets disposed on the guide member,
wherein the two magnets of the first magnet are spaced apart from each other in a direction perpendicular to the direction of the first rotational axis, and
the camera module further comprises a first pulling yoke disposed on the housing and spaced apart from the first magnet in the direction of the first rotational axis.

17. The camera module of claim 15, wherein the plurality of balls of the first ball member are in contact with an outer surface of the protrusion, and
a diameter of each of the plurality of balls of the first ball member is greater than a length of the protrusion in the direction of the first rotational axis.

18. The camera module of claim 15, wherein a lubrication groove is formed in either one or both of a surface of the housing in contact with the plurality of balls of the first ball member and a surface of the guide member in contact with the plurality of balls of the first ball member, and
the camera module further comprises a lubricant disposed in the lubrication groove.

19. The camera module of claim 15, further comprising a second lens module having a second optical axis and disposed on the holder so that the second lens module is disposed in front of the reflective member,
wherein the first optical axis and the second optical axis are perpendicular to each other.

20. The camera module of claim 19, wherein the direction of the first rotational axis is the same as or parallel to a direction of the second optical axis, and
a direction of the second rotational axis is perpendicular to both the first optical axis and the second optical axis.

21. The camera module of claim 19, wherein the direction of the first rotational axis is the same as or parallel to a direction of the first optical axis, and
a direction of the second rotational axis is perpendicular to both the first optical axis and the second optical axis.

22. An optical module comprising:
a housing; and
a reflective module disposed in the housing and configured to be rotatable about a first rotational axis with respect to the housing,
wherein a first guide groove having a circular planar shape centered on the first rotational axis is formed in a surface of the reflective module facing the housing,
a second guide groove having a circular planar shape centered on the first rotational axis is formed in a surface of the housing facing the surface of the reflective module in which the first guide groove is formed,
the optical module further comprises a first ball member comprising a plurality of balls disposed between the first guide groove and the second guide groove, and
the plurality of balls of the first ball member are equidistantly spaced apart from one another in a circumferential direction around the first rotational axis and are configured to roll in the circumferential direction while the reflective module rotates with respect to the housing.

23. The optical module of claim 22, further comprising a protrusion having a circular planar shape centered on the first rotational axis and disposed in either one or both of the first guide groove and the second guide groove,
wherein the plurality of balls of the first ball member are disposed between an outer surface of the protrusion and an inner wall surface of the first guide groove or an inner wall surface of the second guide groove, and are further configured to roll in the circumferential direction while being in contact with the outer surface of the protrusion as the reflective module rotates with respect to the housing.

24. The optical module of claim 22, further comprising a retainer comprising a body and a plurality of supports extending from the body in a direction of the first rotational axis,
wherein the retainer is disposed between the first groove and the second groove so that the plurality of supports are disposed between the plurality of balls of the first ball member.

25. The optical module of claim 24, wherein the plurality of balls of the first ball member comprise a first plurality of balls and a second plurality of balls, and
the first plurality of balls and the second plurality of balls are spaced apart from each other in the direction of the first rotational axis.

26. The optical module of claim 22, further comprising a sub-ball member comprising a plurality of sub-balls disposed between the plurality of balls of the first ball member.

27. The optical module of claim 22, further comprising a barrier wall disposed in either one or both of the first guide groove and the second guide groove and between the plurality of balls of the first ball member.

28. The optical module of claim 22, wherein the reflective module comprises:
a guide member disposed in the housing and configured to be rotatable about the first rotational axis with respect to the housing;
a holder disposed in the guide member and configured to be rotatable together with the guide member about the first rotational axis with respect to the housing, and to be rotatable about a second rotational axis perpendicular to the first rotational axis with respect to the guide member; and
a reflective member disposed in the holder and configured to be rotatable together with the holder and the guide member about the first rotational axis with respect to the housing, and to be rotatable together with the holder about the second rotational axis with respect to the guide member,
wherein the first guide groove is formed in a surface of the guide member facing the surface of the housing in which the second guide groove is formed.

29. A optical module comprising:
a housing;
a reflective module disposed in the housing and configured to be rotatable about a first rotational axis with respect to the housing;
a first coil disposed on a surface of the housing facing the reflective module;
a first magnet disposed on a surface of the reflective module facing the surface of the housing on which the first coil is disposed so that the first magnet faces the first coil; and
a first ball member comprising a plurality of balls disposed between the surface of the housing on which the first coil is disposed and the surface of the reflective module on which the first magnet is disposed,
wherein the first coil and the first magnet are configured to rotate the reflective module about the first rotational axis with respect to the housing, and
the plurality of balls of the first ball member are equidistantly spaced apart from one another other in a circumferential direction around the first rotational axis and are configured to roll in the circumferential direction while the reflective module rotates with respect to the housing.

30. The optical module of claim 29, wherein the first magnet comprises two magnets disposed on opposite sides of the plurality of balls of the first ball member in a direction perpendicular to the first rotational axis, and
the first coil comprises two coils facing the two magnets of the first magnet.

31. The optical module of claim 29, wherein a first guide groove having a circular planar shape centered on the first rotational axis is formed in the surface of the reflective module on which the first magnet is disposed,
a second guide groove having a circular planar shape centered on the first rotational axis is formed in the surface of the housing on which the first coil is disposed, and
the plurality of balls of the first ball member are disposed between the first guide groove and the second guide groove.

32. The optical module of claim 31, further comprising a protrusion having a circular planar shape centered on the first rotational axis and disposed in either one or both of the first guide groove and the second guide groove,
wherein the plurality of balls of the first ball member are disposed between an outer surface of the protrusion and an inner wall surface of the first guide groove or an inner wall surface of the second guide groove, and are further configured to roll in the circumferential direction while being in contact with the outer surface of the protrusion as the reflective module rotates with respect to the housing.
